(19) United States
(12) Patent Application Publication
(10) Pub. No.: US 2014/0343221 A1
(43) Pub. Date: Nov. 20, 2014

(54) POWDER COATING COMPOSITION

(71) Applicant: AXALTA COATING SYSTEMS IP CO., LLC, Wilmington, WA (US)

(72) Inventors: Carmen Flosbach, Wuppertal (DE); Thomas Tuerk, Landshut (DE)

(73) Assignee: AXALTA COATNG SYSTEMS IP CO., LLC, Wilmington, DE (US)

(21) Appl. No.: 14/366,790

(22) PCT Filed: Dec. 17, 2012
(86) PCT No.: PCT/US2012/070088

§ 371 Date: Jun. 19, 2014

Related U.S. Application Data
(60) Provisional application No. 61/578,324, filed on Dec. 21, 2011.
(60) Provisional application No. 61/578,327, filed on Dec. 21, 2011.

(51) Int. Cl. C09D 175/16

(52) U.S. Cl. CPC C09D 175/16
USPC 524/590

(57) ABSTRACT

A powder coating composition includes fluoro-modified polyurethane (meth)acrylate. The fluoro-modified polyurethane (meth)acrylate is prepared from an isocyanate component, a hydroxy-C2-C4-alkyl (meth)acrylate and an alcohol component comprising a perfluoroalkyl alcohol that are reacted stoichiometrically with one another, providing the powder coating composition a fluorine content (calculated as elementary fluorine with molecular mass 19) in a range of about 0.1 to about 3 wt %, the wt % based on the total weight of the powder coating composition The powder coating composition based on the fluoromodified polyurethane (meth)acrylate provides a highly improved flow, chemical resistance and particularly an improved and sustainable self-cleaning effect of the coatings.

### CROSS-REFERENCE TO RELATED APPLICATION

This application is a U.S. National-Stage entry under 35 U.S.C. §371 based on International Application No. PCT/US2012/070088, filed Dec. 17, 2012, which was published under PCT Article 21(2) and which claims priority to U.S. Provisional Application No. 61/578,324, filed Dec. 21, 2011, and to U.S. Provisional Application No. 61/578,327, filed Dec. 21, 2011, which are all hereby incorporated in their entirety by reference.

### TECHNICAL FIELD

The technical field refers to a powder coating composition useful for the preparation of coatings with highly improved flow, chemical resistance and easy-to-clean effect.

### BACKGROUND

Polyurethane (meth) acrylates suitable as binders for the production of powder coating compositions are known, for example, from WO 01/25306, wherein a linear aliphatic diisocyanate, an aliphatic compound with at least two isocyanate-reactive functional groups and an olefinically unsaturated compound with isocyanate-reactive functional group are reacted, in inert organic solvent, and the product is obtained by crystallization and/or re-crystallization.

Crystalline and/or semi-crystalline polyurethane (meth)acrylates suitable as binders for the production of powder coating compositions are known from EP-A 1725598, EP-A 1791887 and EP-A 1828275. They can be produced by reacting diisocyanate component, diol component and hydroxy-C2-C4-alkyl (meth)acrylate, without solvent, wherein the diol component is based on (cyclo)aliphatic diols or a combination of such diols with linear aliphatic C2-C12 diols. The polyurethane (meth)acrylates can be used as binder in powder coating compositions without any purification operations. While providing good acid resistance of the coatings there is a need to develop a powder coating composition based on polyurethane (meth)acrylate binders which provide further improved properties of the coatings, e.g. self-cleanability and others.

It is known in general that the addition of amorphous polyurethanes to crystalline and/or semi-crystalline polyurethanes is suitable to increase the chemical resistance of the coatings, but at the same time, can negatively impact the coating surface, e.g. decrease scratch resistance.

Easy-to-clean powder coating compositions are known providing coatings having a self-cleaning effect. For example, WO 2007059133 discloses a powder coating composition containing hydrophobic agents such as functional alkyl silanes, alkyl siloxanes, fluorine alkyl silanes and fluorine alkyl siloxanes, and perfluorinated hydro carbons. EP-A 772 514 describes surfaces having specific structure consisting of elevations and depths with specific distances, the elevations are made of hydrophobic polymers providing a self-cleaning surface. WO 02/064266 describes coatings providing a particle-based surface structure wherein the particles have an average diameter lower 100 nm, and wherein the coating is at least partially hydrophobic. Unfortunately, the self-cleaning ability of the coatings of prior art often is not stable during the time of exposure of the coated surface to weather.

### SUMMARY

In accordance with an exemplary embodiment, a powder coating composition contains a fluoro-modified polyurethane (meth)acrylate. The fluoro-modified polyurethane (meth)acrylate is prepared from an isocyanate component. a hydroxy-C2-C4-alkyl (meth)acrylate and an alcohol component comprising a perfluoroalkyl alcohol that are reacted stoichiometrically with one another, providing the powder coating composition a fluorine content (calculated as elementary fluorine with molecular mass 19) in a range of about 0.1 to about 3 wt %, the wt % based on the total weight of the powder coating composition.

The powder coating composition based on the fluoromodified polyurethane (meth)acrylate provides a highly improved flow, chemical resistance and particularly an improved and sustainable self-cleaning effect of the coatings.

### DETAILED DESCRIPTION

The features and advantages of the present invention will be more readily understood, by those of ordinary skill in the art, from reading the following detailed description. It is to be appreciated that those certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The disclosure of value ranges is intended as a continuous range of values including every value between the minimum and maximum values.

In accordance with an exemplary embodiment, a powder coating composition contains a fluoro-modified polyurethane (meth)acrylate. The fluoro-modified polyurethane (meth)acrylate is prepared from an isocyanate component, a hydroxy-C2-C4-alkyl (meth)acrylate and an alcohol component comprising a perfluoroalkyl alcohol that are reacted stoichiometrically with one another, providing the powder coating composition a fluorine content (calculated as elementary fluorine with molecular mass 19) in a range of about 0.1 to about 3 wt %, the wt % based on the total weight of the powder coating composition.

The term (meth) acrylic is respectively intended to mean acrylic and/or methacrylic.

The fluorine content (calculated as elementary fluorine with molecular mass 19) of the powder coating composition contemplated herein is in the range of about 0.1 to about 3 wt %, preferably about 0.1 to about 2 wt %, the wt % based on the total weight of the powder coating composition. The fluorine content of the powder coating composition is provided by the content of the fluoro-modified polyurethane (meth)acrylate in the powder coating composition and particularly by the amount of the perfluoroalkyl alcohol used for the preparation of the fluoro-modified polyurethane (meth)acrylate.

The fluoro-modified polyurethane (meth)acrylate can be selected from the group consisting of amorphous, crystalline and/or semi-crystalline fluoro-modified polyurethane (meth)acrylates.

The terms amorphous, crystalline and semi-crystalline stated herein are known at a skilled person. Amorphous substances can be defined by glass transition temperatures (Tg), and crystalline and/or semi-crystalline substances can be defined by melting temperatures (Tm). The term Tg is the glass transition temperature of the solid component(s) measured by means of differential scanning calorimetry (DSC) according to ISO 11357-2. The term Tm is the melting temperature of the solid component(s) measured by means of DSC at heating rates of 10 K/min according to DIN 53765-B-10. The melting temperature is not in general a sharp melting point, but instead the upper end of melting range with a breadth.

The at least one fluoro-modified polyurethane (meth)acrylate may have a number-average molar mass (Mn) in the range of, for example, 500 to 15000, preferably 1000 to 12000.

The number-average molar mass data stated herein are number-average molar masses determined or to be determined by gel permeation chromatography (GPC; divinylbenzene-cross-linked polystyrene as the immobile phase, tetrahydrofuran as the liquid phase, polystyrene standards).

The alcohol component for the production of the fluoro-modified polyurethane (meth)acrylate contemplated herein comprises the perfluoroalkyl alcohol in a content providing the powder coating composition a fluorine content in a range of about 0.1 to about 3 wt %, preferably about 0.1 to about 2 wt %, the wt % based on the total weight of the powder coating composition.

For example, the alcohol component for the production of the fluoro-modified polyurethane (meth)acrylate comprises the perfluoroalkyl alcohol forming at least about 5 mol % within the alcohol component, preferably about 10 to about 98 mol %, more preferred about 10 to about 90 mol %, wherein the mol % of the respective alcohols of the alcohol component add up to 100 mol %, providing the powder coating composition contemplated herein with the fluorine content as mentioned above, with a given content of the fluoro-modified polyurethane (meth)acrylate in the powder coating composition. For example, the perfluoroalkyl alcohol Polyfox™ 656 (Omnova Solutions) as stated herein forming about 10 mol % within the alcohol component for the production of the fluoro-modified polyurethane (meth)acrylate, wherein the mol % of the respective alcohols of the alcohol component add up to 100 mol %, provide the powder coating composition contemplated herein with a fluorine content of about 0.22 wt % when using a content of about 5 wt % of such prepared fluoro-modified polyurethane (meth)acrylate in the powder coating composition, the wt % based on the total weight of the powder coating composition.

The fluorine content (calculated as elementary fluorine with molecular mass 19) of the powder coating composition in a range of about 0.1 to about 3 wt %, preferably about 0.1 to about 2 wt %, the wt % based on the total weight of the powder coating composition, can also be provided by the perfluoroalkyl alcohol forming less than about 10 mol %, preferably about 0.1 to about 8 mol % within the alcohol component for the production of the fluoro-modified polyurethane (meth)acrylate, wherein the mol % of the respective alcohols of the alcohol component add up to 100 mol %, when using a content of higher then about 5 wt %, preferably about 30 to about 90 wt %, of such prepared fluoro-modified polyurethane (meth)acrylate in the powder coating composition, the wt % based on the total weight of the powder coating composition.

The perfluoroalkyl alcohol can be a perfluoroalkyl containing polymeric polyol and/or a perfluoroalkyl containing monoalkohol.

The perfluoroalkyl-containing polymeric polyol can be an aliphatic and/or cycloaliphatic polyether polyol having —OCH₂CF₂ₙ₊₁ groups with n=1 or 2, and it can be prepared from a polyether polyol wherein a number of the hydroxyl groups have been etherified with an alcohol of the formula CₙF₂ₙ₊₁CH₂OH with n=1 or 2, and wherein two or more hydroxyl groups are unetherified free hydroxyl groups in the molecule. The fluorine-containing polyether polyol has a fluorine content provided by its —OCH2CnF2n+1 groups in the range of, for example, about 24 to about 40 wt %, and it may have a calculated molar mass in the range of, for example, about 470 to about 5000.

Preferred examples are fluorine-containing polyether diols with the formula HO[CH₂CCH₃CH₂OCH₂CF₃CH₂O]ₓCH₂C(CH₃)₂CH₂—[OCH₂CCH₃CH₂OCH₂CF₃CH₂]_{y}OH and with the formula HO[CH₂CCH₃CH₂OCH₂C₂F₅CH₂O]ₓCH₂C(CH₃)₂CH₂—[OCH₂CCH₃CH₂OCH₂C₂F₅CH₂]_{y}OH, with x+y=6 on average.

The perfluoroalkyl-containing monoalkohol can be a perfluoroalkyl ethanol of the formula F-(CF₂)n⁻CH₂CH₂OH with n=2-8, for example, perfluorobutyl ethanol, perfluorohexyl ethanol and/or perfluorooctyl ethanol. The fluorine-containing monoalcohol has a fluorine content provided by its F-(CF2)n⁻ groups in the range of, for example, about 65 to about 70 wt %, and it may have a number-average molar mass in the range of, for example, about 416- about 528.

Examples of commercially available products are Polyfox™ 636 (Omnova Solutions), Polyfox™ 656 (Omnova Solutions) and Zonyl® BA-types (DuPont).

The alcohol component for the production of the fluoromodified polyurethane (meth)acrylates further comprises alcohols which are diols or polyols in the form of low molar mass compounds defined by empirical and structural formula and/or oligomeric or polymeric polyols with number-average molar masses of, for example, up to about 800, for example, corresponding hydroxyl-functional polyethers, hydroxyl-functional polyesters and/or hydroxyl-functional polycarbonates.

Low molar mass diols defined by an empirical and structural formula are, however, preferred. Examples of such low molar mass diols are ethylene glycol, the isomeric propane-and butanediols, 1,5-pentanediol, 1,6-hexanediol, 1,10-decanediol, 1,12-dodecanediol, 1,4-cyclohexanedimethanol, hydrogenated bisphenol A, dimer fatty alcohol, neopentyl glycol, butylethylpropanediol, the isomeric cyclohexanediols, the isomeric cyclohexanedimethanols, tricyclodecanedimethanol.

Examples of polyols defined by empirical and structural formula are polyols with more than two hydroxyl groups such as trimethylolpropane, trimethylolethane and pentaerythrite.

The isocyanate component for the production of the fluoro-modified polyurethane (meth)acrylate contemplated herein comprises isocyanate(s) as known by a skilled person for the production of polyurethanes. Examples are diisocyanates such as 1,6-hexane diisocyanate, tetramethylxylylene diisocyanate, isophorone diisocyanate, dicyclohexylmethane diisocyanate and cyclohexane diisocyanate, but also polyisocyanates derived from these diisocyanates, like for example, uretidione or isocyanurate type polyisocyanates produced by di- or trimerization of these diisocyanates or polyisocyanates produced by reaction of these diisocyanates with water and containing biuret groups or urethane group containing polyisocyanates produced by reaction of these diisocyanates with polyols.

A hydroxy-C2-C4-alkyl (meth)acrylate is used for the production of the fluoromodified polyurethane (meth)acrylate contemplated herein. Examples of hydroxy-C2-C4-alkyl (meth)acrylates are hydroxyethyl (meth)acrylate, one of the isomeric hydroxypropyl (meth)acrylates or one of the isomeric hydroxybutyl (meth)acrylates. The acrylate compound is preferred in each case.

The person skilled in the art selects the nature and proportion of the diisocyanate component, the alcohol component comprising the perfluoroalkyl alcohol and the hydroxy-C2-C4-alkyl (meth)acrylate for the production of the fluoro-modified polyurethane (meth)acrylates in such a manner providing the powder coating composition a fluorine content (calculated as elementary fluorine with molecular mass 19) in a range of about 0.1 to about 3 wt %, the wt % based on the total weight of the powder coating composition.

For specific applications, for example to provide additional specific properties of the coatings such as scratch resistance, specific fluoro-modified polyurethane (meth)acrylates can be used in the powder coating composition contemplated herein. For those purposes the specific fluoro-modified polyurethane (meth)acrylates can be prepared particularly based on the following three embodiments of preparation.

In a first embodiment of preparation, 1,6-hexane diisocyanate is reacted stoichiometrically with the alcohol component comprising the perfluoroalkyl alcohol and with the hydroxy-C2-C4-alkyl (meth)acrylate in the molar ratio x:(x-1):2 wherein x means a value from about 2 to about 5, preferably from about 2 to about 4. The alcohol component is a combination of the perfluoroalkyl alcohol and two to four, preferably of two or three, different (cyclo)aliphatic diols with molar masses of 62 to 600 wherein each of the alcohols constitutes at least 10 mol % within the alcohol component wherein the mol % of the respective alcohols add up to 100 mol %. Examples of (cyclo)aliphatic diols are ethylene glycol, the isomeric propane- and butanediols, 1,5-pentanediol, 1,6-hexanediol, 1,10-decanediol, 1,12-dodecanediol, neopentyl glycol, butylethylpropanediol, the isomeric cyclohexanediols, the isomeric cyclohexanedimethanols, hydrogenated bisphenol A, tricyclodecanedimethanol and dimer fatty alcohol.

In a second embodiment of preparation, a trimer of a (cyclo)aliphatic diisocyanate, 1,6-hexanediisocyanate, the alcohol component comprising the perfluoroalkyl alcohol and the hydroxy-C2-C4 alkyl(meth)acrylate are reacted stoichiometrically with one another in the molar ratio 1:x:x:3 wherein x means a value from 1 to 6, preferably from 1 to 3. The alcohol component is a combination of the perfluoroalkyl alcohol and an at least one individual linear aliphatic alpha,omega C2-C12 diol and two to four, preferably two or three, different (cyclo)aliphatic diols, wherein each of the alcohols makes up at least 10 about mol % within the alcohol component and wherein the alcohol component consists of at least about 80 mol % of the linear aliphatic alpha,omega C2-C12 diol wherein the mol % of the respective alcohols add up to 100 mol %.

The trimer of the (cyclo)aliphatic diisocyanate is polyisocyanates of the isocyanurate type, prepared by trimerization of a (cyclo)aliphatic diisocyanate.

Examples of the individual linear aliphatic alpha, omega C2-C12 diol are ethylene glycol, 1,3-propanediol, 1,4-butanediol, 1,5-pentanediol, 1,6-hexanediol, 1,10-decanediol, 1,12-dodecanediol.

Examples of the (cyclo)aliphatic diols are the further isomers of propane and butane diol, different from the isomers of propane and butane diol cited in the preceding paragraph, and neopentylglycol, butylethylpropanediol, the isomeric cyclohexane diols, the isomeric cyclohexanedimethanols, hydrogenated bisphenol A and tricyclodecanedimethanol.

In a third embodiment preparation, the diisocyanate component, the alcohol component comprising the perfluoroalkyl alcohol and the hydroxy-C2-C4-alkyl (meth)acrylate are reacted stoichiometrically with one another in the molar ratio x:(x-1):2 wherein x means a value from about 2 to about 5, preferably from about 2 to about 4, wherein about 50 to about 80 mol % of the diisocyanate component is formed by 1,6-hexane diisocyanate, and about 20 to about 50 mol % by one or two diisocyanates wherein the mol % of the respective diisocyanates add up to 100 mol %. The alcohol component is a combination of the perfluoroalkyl alcohol and no more than four different diols wherein about 20 to about 100 mol % of the diols is formed by at least one linear aliphatic alpha, omega-C2-C12-diol, and 0 to about 80 mol % of the diols by at least one (cyclo)aliphatic diol that is different from linear aliphatic alpha,omega-C2-C12-diols wherein the mol % of the respective alcohols add up to 100 mol %.

The further one or two diisocyanates forming about 20 to about 50 mol % of the diisocyanate component are selected from the group consisting of toluylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate.

Examples of the at least one linear aliphatic alpha, omega-C2-C12-diols are those described for the second embodiment.

Examples of the (cyclo)aliphatic diols that are different from linear aliphatic alpha,omega-C2-C12-diols are those described for the second embodiment of the process described herein.

In the process for the production of the fluoro-modified polyurethane (meth)acrylates contemplated herein the isocyanate component, the alcohol component comprising the perfluoroalkyl alcohol and the hydroxy-C2-C4-alkyl (meth)acrylate are reacted with one another in substance, in the absence of a solvent.

The term solvent stated in the present description means an organic solvent or mixture of organic solvents, as known in the art. In the process for the production of the fluoro-modified polyurethane (meth)acrylates solvent may be used, in general, for example, in an amount of 0 to about 50 wt %, the wt % based on the total amount of the fluoro-modified polyurethane (meth)acrylate solution which, however, makes it necessary to remove the solvent from the resulted resins. Preferably, the production of the fluoro-modified polyurethane (meth)acrylates is carried out without solvent and without subsequent purification operations.

The reactants may all be reacted together simultaneously or in two or more synthesis stages. When the synthesis is performed in multiple stages, the reactants may be added in the most varied order, for example, also in succession or in alternating manner. For example, the diisocyanates of the diisocyanate component may be reacted first with hydroxy-C2-C4-alkyl (meth)acrylate and then with the alcohols of the alcohol component, or first with the alcohols of the alcohol component and then with hydroxy-C2-C4-alkyl (meth)acrylate. However, the alcohol component may also be divided into two or more partial amounts, for example, or into the individual alcohols, for example, such that the diisocyanates are reacted first with a portion of the alcohol component, prior to the further reaction with hydroxy-C2-C4-alkyl (methyl)acrylate, and finally with the remaining proportion of the alcohol component, for example. Equally, however, the diisocyanate component may also be divided into two or more partial amounts, for example, or into the individual diisocyanates, for example, such that the alcohols are reacted first with a portion of the diisocyanate component and finally with the remaining proportion of the diisocyanate component, for example. The individual reactants may in each case be added in their entirety or in two or more portions.

The reaction is exothermic and proceeds at a temperature above the melting temperature of the reaction mixture, but below a temperature, which results in free-radical polymerization of the (meth)acrylate double bonds.

The reaction temperature is, for example, about 60 to a maximum of about 120° C. The rate of addition or quantity of reactants added is accordingly determined on the basis of the degree of exothermy and the liquid (molten) reaction mixture may be maintained within the desired temperature range by heating or cooling.

Once the reaction is complete and the reaction mixture has cooled, solid fluoromodified polyurethane (meth)acrylates are obtained. The fluoromodified polyurethane (meth)acrylates assume the form of a mixture exhibiting a molar mass distribution. The fluoromodified polyurethane (meth)acrylates do not, however, require working up and may be used directly as a powder coating binder.

The fluoro-modified polyurethane (meth)acrylates may be used in the powder coating composition not only as sole binder or as main binder constituting at least about 50 wt %, but also in smaller proportions as co-binder, for example in amounts from about 30 to about 50 wt %, or as additive, for example in amounts from about 0.5 to about 10 wt %, the wt % based on the total powder coating composition.

In respect to this the powder coating composition contemplated herein may comprise additional suitable binders known as such in the art of paints and coatings by a skilled person which are different from the fluoro-modified polyurethane di(meth)acrylates. Examples are binders curable by free-radical polymerization of olefinic double bonds, such as unsaturated polyesters, polyurethanes, and/or (meth)acrylic copolymer resins, polymer hybrid resins derived from these classes of resin binders, with a number-average molar mass (Mn) in the range of, for example, about 500 to about 10000.

The powder coating composition contemplated herein comprises pigments, fillers and/or coating additives known at a skilled person in a range of about 0.1 to about 60 wt %, preferably about 5 to about 60 wt %, based on the total powder coating composition.

The pigments can be transparent pigments, color-imparting and/or special effect-imparting pigments and/or fillers (extenders), for example, corresponding a pigment plus filler: resin ratio by weight in the range from 0:1 to 2:1. Examples of inorganic or organic color-imparting pigments are titanium dioxide, iron oxide pigments, carbon black, azo pigments, phthalocyanine pigments, quinacridone or pyrrolopyrrole pigments. Examples of special effect-imparting pigments are metal pigments, for example, made from aluminum, copper or other metals; interference pigments, such as, for example, metal oxide coated metal pigments, for example, titanium dioxide coated or mixed oxide coated aluminum, coated mica, such as, for example, titanium dioxide coated mica.

Examples of usable fillers are silicon dioxide, aluminum silicate, barium sulfate, calcium carbonate and talcum.

Coating additives are, for example, inhibitors, catalysts, levelling agents, degassing agents, wetting agents, anticratering agents, initiators, antioxidants and light stabilizers. The additives are used in conventional amounts known to the person skilled in the art.

The components of the powder coating composition are mixed, extruded and ground by conventional techniques employed in the powder coatings art familiar to a person of ordinary skill in the art. Typically, all of the components of the present powder coating formulation are added to a mixing container and mixed together. The blended mixture is then melt blended, for example, in a melt extruder. Also, components can be melt blended with the molten fluoro-modified polyurethane (meth)acrylate. The melt blended, for example extruded, composition is then cooled and broken down and ground to a powder. The ground powder is subsequently screened to achieve the desired particle size, for example, an average particle size (mean particle diameter) of 20 to 200 μm, determined by means of laser diffraction.

It is possible that a predetermined amount of a component of the powder coating components be added, for example, to the further components of the composition, and then premixed. The premix can then be extruded, cooled, and thereafter pulverized and classified.

The powder coating composition may also be prepared by spraying from supercritical solutions, NAD “non-aqueous dispersion” processes or ultrasonic standing wave atomization process.

Furthermore, specific components of the powder coating composition, for example, additives, pigment, fillers, may be processed with the finished powder coating particles after extrusion and grinding by a “bonding” process using an impact fusion. For this purpose, the specific components may be mixed with the powder coating particles. During blending, the individual powder coating particles are treated to softening their surface so that the components adhere to them and are homogeneously bonded with the surface of the powder coating particles. The softening of the powder particles' surface may be done by heat treating the particles to a temperature, e.g., about 40 to about 100° C., dependent from the melt behavior of the powder particles. After cooling the mixture the desired particle size of the resulted particles may be proceed by a sieving process.

The powder coating compositions can be readily applied to metallic and non-metallic substrates, in a dry-film thickness of dry film thickness of about 10 to about 300 μm, preferably about 20 to about 100 μm, particularly from about 10 to about 50 μm for thin film coatings.

The compositions can be used to coat metallic substrates including, but not limited to, steel, brass, aluminum, chrome, and mixtures thereof, and also to other substrates including, for example, heat-sensitive substrates, such as, substrates based on wood, plastics and paper, and other substrates based, for example, on glass and ceramics.

Depending upon the requirements placed upon the coated substrate, the surface of the substrate may be subjected to a mechanical treatment, such as, blasting followed by, in case of metal substrates, acid rinsing, or cleaning followed by chemical treatment.

The powder coating composition may be applied by, e.g., electrostatic spraying, electrostatic brushing, thermal or flame spraying, fluidized bed coating methods, flocking, tribostatic spray application and the like, also coil coating techniques, all of which are known to those skilled in the art.

Prior to applying the coating composition the substrate may be grounded but not pre-heated, so that the substrate is at an ambient temperature of about 25° C.

In certain applications, the substrate to be coated may be pre-heated before the application of the powder coating composition, and then either heated after the application of the powder composition or not. For example, gas is commonly used for various heating steps, but other methods, e.g., microwaves, infra red (IR), near infra red (NIR) and/or ultra violet (UV) irradiation are also known. The pre-heating can be to a temperature ranging from about 60 to about 260° C. using means familiar to a person of ordinary skill in the art.

The powder coating compositions can be applied directly on the substrate surface as a primer coating or on a layer of a primer which can be a liquid or a powder based primer. The powder coating composition can also be applied as a coating layer of a multilayer coating system based on liquid or powder coats, for example, as clear coat layer applied onto a color-imparting and/or special effect-imparting base coat layer or as pigmented one-layer coat applied onto a prior coating.

After being applied, the coating can be melted by exposing by convective, gas and/or radiant heating, e.g., IR and/or NIR irradiation, as known in the art, to temperatures of, e.g. about 100° C. to about 300° C., preferably, about 120° C. to about 200° C., object temperature in each case, for, e.g., about 2 to about 20 minutes in case of pre-heated substrates, and, for example, about 4 to about 30 minutes in case of non-pre-heated substrates.

After melting the applied powder coating composition can be cured by free-radical polymerization of olefinic double bonds which cure thermally and/or by irradiation with high-energy radiation known by a skilled person. UV (ultraviolet) radiation or electron beam radiation may be used as high-energy radiation. UV-radiation is the preferred high-energy radiation. Irradiation may proceed continuously or discontinuously.

While thermally curable powder coatings contain thermally cleavable free-radical initiators, the powder coating compositions curable by UV irradiation contain photoinitiators. The initiators can be used, for example, in amounts of about 0.1 to about 7 wt %, preferably of about 0.5 to about 5 wt %, based on the total powder coating composition contemplated herein. The initiators may be used individually or in combination.

Examples of thermally cleavable free-radical initiators are azo compounds, peroxide compounds and C-C-cleaving initiators, as known by a person skilled in the art. Examples of photoinitiators are benzoin and derivatives thereof, acetophenone, benzophenone, thioxanthone and derivatives thereof, anthraquinone, 1-benzoylcyclohexanol, organophosphorus compounds as known by a person skilled in the art.

The coating layer may be exposed by convective, gas and/or radiant heating, e.g., infra red (IR) and/or near infra red (NIR) irradiation, as known in the art, to temperatures of, e.g. about 100° C. to about 300° C., preferably of about 120 to about 250° C., more preferably about 120° C. to about 180° C. (object temperature in each case).

The self-cleaning properties of the coatings provided by the powder coating composition can be determined by testing the initial self-cleaning ability of a coating layer on a panel by applying Leverkusen standard dirt 09 LD-40 (commercially available from wfk institute Krefeld, Germany) on the horizontally positioned coated panel, using a sieve, to the horizontally positioned panel. Then, 10 ml of water droplets are placed on the unsoiled area of the coated panel. The unsoiled end of the panel is slowly and continuously raised from the horizontal position to a more vertical position, and angle at which the water droplets begin to move is recorded. After the water droplets have reached the bottom end of the panel it is visually rated how much dirt the water droplets have removed from the surface. The coated panel is then carefully cleaned to remove any remaining dirt, and is subjected to artificial weathering conditions (1000h CAM 180 artificial weathering test). The artificially weathered panel is then subjected to the same self-cleaning ability test as described above, and this is repeated again. Finally, a trend can be estimated, if or to what extent the self-cleaning ability reduces over time.

The following examples illustrate the various embodiments.

### EXAMPLES

### Example 1

### Preparation of a Fluoro-Modified Polyurethane (meth)acrylate as Described Herein

In a 21-four neck glass reactor equipped with stirrer, thermo couple and column 43,1 wt % of 1,6-Hexandiisocyanate (HDI) are mixed with 0,3 wt % of methylhydrochinone and 0,01 wt % dibutyltindilaurate. The mixture is heated to 60° C., and 19,8 wt % of hydroxyethylacrylate is dosed in such a way that a temperature of 80° C. is not exceeded. The mixture is kept at 80° C. till the target NCO-value is reached. After having reached the target NCO-content 20,5 wt % of hydrogenated Bisphenol A, 1,5% of Polyfox™ 656 (commercially available from Omnova) and 14,7 weight-% of 1,10-Dekandiol are added one after the other in such a way that a temperature of 120° C. is not exceeded. The temperature is kept at 120° C. till no NCO-value is detectable. The molten resin is filled off and cooled down.

### Example 2

### Preparation of a Polyurethane (meth)acrylate According to Prior Art

In a 21-four neck glass reactor equipped with stirrer, thermo couple and column 43,7 wt % of 1,6-hexandiisocyanate (HDI) are mixed with 0,3 weight.-% of methylhydrochinone and 0,01 wt % dibutyltindilaurate. The mixture is heated to 60° C. and 20,1 weight-% of hydroxyethylacrylate is dosed in such a way that a temperature of 80° C. is not exceeded. The mixture is kept at 80° C. till the target NCO-value is reached. After having reached the target NCO-content 20,8 wt % of hydrogenated Bisphenol A and 15,1 wt % of 1,10-Dekandiol are added one after the other in such a way that a temperature of 120° C. is not exceeded. The temperature is kept at 120° C. till no NCO-value is detectable. The molten resin is filled off and cooled down.

### Example 3

### Preparation of Powder Coating Compositions, Application and Test Results

Via premixing and extrusion of a crushed mixture of 96,5 wt % of the fluoro-modified polyurethaneacrylate of Example 1, 1 wt % Irgacure® 2959 (Photoinitiator from Ciba), 0.5 wt % Powdermate® 486 CFL (flow additive from Troy Chemical Company), 1 wt % Tinuvin® 144 (HALS-Light stabilizer from Ciba) and 1 wt % Tinuvin® 405 (UV-Absorber from Ciba) a powder clear coat is prepared according to standard powder manufacturing process (cooling, breaking, milling and sieving).

The powder clear coat is applied with a film thickness of 80 μm onto steel panels, molten for 10 min at 140° C. (oven temperature) and after that irradiated with UV-light with an intensity of 500 mW/cm2 and a UV-dose of 800 mJ/cm2.

The self-cleanability of a coating layer over time can be determined by the following method. First, the initial self-cleanability of a panel provided with the coating layer to be tested is determined by applying Leverkusen standard dirt 09 LD-40 (commercially available from wfk institute Krefeld, Germany) to all but a 4 centimeter portion of one end of the horizontally positioned panel. Dirt application is performed making use of a sieve. Three 25 μl drops of deionized water are placed on the unsoiled area of the coated panel. The unsoiled end of the panel is slowly and continuously raised from the horizontal position to a 30° angle causing the water drops to move through the soiled area. After 5 minutes the position of the water drops is recorded and it is visually rated how much dirt the water drops on their move downwards have removed from the surface. The coated panel is then carefully cleaned to remove any remaining dirt and it is thereafter subjected to artificial weathering conditions (500 hours according to SAE J2527, CAM 180 artificial weathering test). Then the self-cleanability test is repeated followed by further cycles of artificial weathering and self-cleanability testing. Finally, self-cleanability data comprising the initial self-cleanability and self-cleanability after 500, 1000 and 2000 hours of artificial weathering are obtained and a trend can be estimated, if or to what extent the self-cleanability of the coating layer reduces over time when exposed to the weather.

### Test Results:

TABLE 1

| | | | | dirt | dirt | dirt |
|---|---|---|---|---|---|---|
| | | chemical | dirt | removal*** | removal*** | removal*** |
| coating based | | resistance** | removal*** | after 500 h | after 1000 h | after 2000 h |
| on | flow * | (min) | initial | CAM 180 | CAM 180 | CAM 180 |
| Example 1 | excellent | 30 | 100% | 98% | 90% | 75% |
| Example 2 | good | 23 | 90% | 74% | 50% | 10% |

* visual rating
**Chemical resistance test: The panel is placed on a heating plate at 65° C. Over a time period of 30 min droplets of 50 μl of 36% sulfuric acid are placed on the clear coat surface in intervals of 1 min. Rating: destruction of the film after x min (0-30).
***how much dirt is removed by the self cleaning ability test described before

1. A powder coating composition comprising a fluoro-modified polyurethane (meth)acrylate prepared from an isocyanate component, a hydroxy-C2-C4-alkyl (meth)acrylate and an alcohol component comprising a perfluoroalkyl alcohol reacted stoichiometrically with one another, wherein the powder coating composition has a fluorine content (calculated as elementary fluorine with molecular mass 19) in a range of about 0.1 to about 3 wt %, the wt % based on the total weight of the powder coating composition, and wherein the perfluoroalkyl alcohol comprises a perfluoralkyl-containing polymeric polyol being an aliphatic and/or cycloaliphatic polyether polyol having —OCH₂F₂ₙ₊₁ groups with n=1 or 2.

2. The powder coating composition according to claim 1 wherein the fluorine content (calculated as elementary fluorine with molecular mass 19) is in a range of about 0.1 to about 2 wt %.

3. The powder coating composition according to claim 1 wherein the perfluoroalkyl alcohol comprises a perfluoroalkyl-containing polymeric polyol and/or a perfluoroalkyl-containing monoalkohol.

4. (canceled)

5. (canceled)

6. The powder coating composition according to claim 1 wherein 1,6-hexane diisocyanate as the isocyanate component is reacted stoichiometrically with the alcohol component comprising the perfluoroalkyl alcohol and with the hydroxy-C2-C4-alkyl (meth)acrylate in a molar ratio x:(x-1):2.

7. The powder coating composition according to claim 1 wherein the fluoro-modified polyurethane (meth)acrylate is a sole binder or a main binder constituting present in an amount of at least about 50 wt %, the wt % based on the total powder coating composition.

8. The powder coating composition according to claim 1 wherein the fluoro-modified polyurethane (meth)acrylate is used as a co-binder present in an amount of from about 30 to about 50 wt %, or as an additive in amounts from about 0.5 to about 10 wt %, the wt % based on the total powder coating composition.

9. A process for the preparation of a powder coating composition comprising a fluoro-modified polyurethane (meth)acrylate, the process comprising reacting an isocyanate component, an alcohol component comprising a perfluoroalkyl alcohol and a hydroxy-C2-C4-alkyl (meth)acrylate with one another in substance in the absence of a solvent wherein the powder coating composition has a fluorine content (calculated as elementary fluorine with molecular mass 19) in a range of about 0.1 to about 3 wt %, the wt % based on the total weight of the powder coating composition, and wherein the perfluoroalkyl alcohol comprises a perfluoralkyl-containing polymeric polyol being an aliphatic and/or cycloaliphatic polyether polyol having —OCH₂F₂ₙ₊₁ groups with n=1 or 2.

10. A substrate coated with a powder coating composition comprising a fluoro-modified polyurethane (meth)acrylate prepared from an isocyanate component, a hydroxy-C2-C4-alkyl (meth)acrylate and an alcohol component comprising a perfluoroalkyl alcohol reacted stoichiometrically with one another, wherein the powder coating composition has a fluorine content (calculated as elementary fluorine with molecular mass 19) in a range of about 0.1 to about 3 wt %, the wt % based on the total weight of the powder coating composition, and wherein the perfluoroalkyl alcohol comprises a perfluoralkyl-containing polymeric polyol being an aliphatic and/or cycloaliphatic polyether polyol having —OCH₂F₂ₙ₊₁ groups with n=1 or 2.
